(19) United States
(12) Patent Application Publication
(10) Pub. No.: US 2010/0136153 A1
(43) Pub. Date: Jun. 3, 2010

(54) PREPARATION OF INDIVIDUALLY COATED COMPOSITE FRUIT PRODUCTS

(75) Inventors: Rogelio Caballero, Col. Reforma Iztaccihuatl (MX); Cynthia Meza, Col San Jose Insurgentes (MX); Karla Ochoa, Col. Sinatel, Mexico City (MX)

Correspondence Address: CARSTENS & CAHOON, LLP, P O BOX 802334, DALLAS, TX, 75380, US

(73) Assignee: SABRITAS, S. DE R.L. DE C.V., Col. Bosques de las Lomas (MX)

(21) Appl. No.: 12/325,781

(22) Filed: Dec. 1, 2008

(51) Int. Cl. A23G 3/54; A23P 1/08; A23G 3/02; A23G 3/20; A23G 3/06; A23P 1/12

(52) U.S. Cl. 425/94; 426/273; 426/102

(57) ABSTRACT

A method and apparatus for producing individually coated, baked, composite fruit core snack products is disclosed. Wet and dry ingredients are mixed and extruded to make a fruit paste rope. The fruit paste rope is divided into individual sections and formed into cores, each of which is substantially shaped into a sphere. The cores are then coated and baked to produce the coated composite fruit snack product.

### BACKGROUND OF THE INVENTION

1. Technical Field

The present invention relates to a method of making individually coated, baked composite fruit snack products.

2. Description of Related Art

Coated edible food products in the prior art comprise a generally cohesive core food product, such as a nut piece or piece of fruit, which has been coated with a material that modifies or enhances the flavor or texture properties of the core, and cooked. Examples of coated edible cores are chocolate coated nuts, honey roasted nuts, and chocolate covered raisins.

With specific regard to coated fruit, the prior art is severely limited in the variety of flavors, textures and nutritional profiles that have been provided to consumers. U.S. Pat. No. 4,961,943 discloses a method of making coated pieces of dried fruit, including raisins, prunes, cherries, apples, pineapple, figs, bananas, dates, currants, apricots and cranberries. The coating comprises an oil- and cereal-based mixture. The use of only dried fruit pieces limits the number and variety of flavors and textures that can be provided. U.S. Pat. No. 5,698,248 also discloses coating dried pieces of fruits and vegetables with a fat based coating. Thus, the prior art primarily provides coated products to consumers that are limited in flavor to single fruits, limited in texture to dried pieces of fruit, and nutrition to only such nutrients as single pieces of can provide. The prior art coatings are also all very high in fat.

It would be an improvement in the art, therefore to provide individual baked edible fruit based cores that allow, more variability in the types of products produced.

### SUMMARY OF THE INVENTION

The present invention is a method and apparatus designed to provide individual baked, coated, fruit-based cores comprising a composite center and an expanded, crispy coating. A composite fruit core is made by first mixing dry and wet ingredients to form a fruit paste, and then extruding the mixture to form a fruit paste rope. The fruit paste rope is then cut into individual rope sections. The rope sections are then formed into composite fruit cores, each substantially in the shape of an ellipsoid. In a preferred embodiment they are each rolled substantially in the shape of a spheroid, and in a most preferred embodiment, they are each rolled substantially into the shape of a sphere. The composite fruit cores are then cooled. The cooled composite fruit cores are then coated with a sugar, water and starch mixture, preferably in a rotating pear drum. The coated spheres are then baked to form a crispy crust surrounding the relatively moist fruit core. The baked, coated cores can then be seasoned to taste, and packaged.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawing, wherein:

FIG. 1 depicts a schematic diagram of one embodiment of the present invention;

FIG. 2 depicts a perspective view of one embodiment of the core former of the present invention;

FIG. 3 depicts a profile view of one embodiment of the core former of the present invention;

FIG. 4 depicts a cut away perspective view of one embodiment of the coated core snack food of the present invention.

### DETAILED DESCRIPTION

An apparatus and method for making a snack product comprising individual baked, coated composite fruit cores is disclosed. Unless stated otherwise, all percentages are deemed to be weight percentages.

In a first processing step, dry ingredients (powders and granular ingredients) are mixed in a high efficiency mixer. The high efficiency mixer is preferably a plowshare mixer. A plowshare mixer employs plow shaped mixing tools attached to its central shaft. As the shaft rotates, the plows lift and fluidize the dry ingredients. The fluidization action of the plowshare mixer helps avoid lump formation in the fruit powder ingredients especially. Fruit powders are highly hygroscopic, and tend to form lumps. The fluidized plowshare action agitates and individualizes the solid particles in each dry ingredient, resulting in a smooth, homogeneous mixture which can be then be mixed with the wet ingredients.

As used herein, the term fruit is used in the culinary sense and includes those botanical fruits that are sweet and fleshy. Examples of fruit include, without limitation, apple, strawberry, blueberry, cranberry, plum, peach, mango, banana, pear, grape and orange. The term fruit powder, as used herein, is defined as partially dehydrated flakes of fruit solids. Typically, fruit powder will contain between about 1% and about 4% moisture. Fruit powder may also contain ingredients such as rice flour and/or lecithin as processing aids. In one embodiment, the fruit powder contains apple. In another embodiment, the fruit powder contains apple, blueberry, cranberry, and strawberry. In still another embodiment, the fruit powder contains apple, peach and mango. The particular blend of fruit powders is chosen for considerations such as flavor (sweetness), cost, color, sugar content and fruit solids content.

In one embodiment, the dry ingredients comprise fruit powder, wheat flour and sugars. In a preferred embodiment, the dry ingredients comprise fruit powder, wheat flour, maltodextrin, starch, citric acid, and water. In a most preferred embodiment, the dry ingredients comprise apple powder, wheat flour, maltodextrin, modified (pregelatinized) starch, citric acid, mandarin orange flavor, mango flavor and pineapple flavor.

The blended dry ingredients are then mixed with the wet ingredients. In one embodiment, the wet ingredients comprise water, polydextrose and glycerin. Enough water is added to hydrate the mixture to a moisture content between about 7% and about 15%. Preferably, a planetary mixer is used. The resulting mixture is a fruit paste.

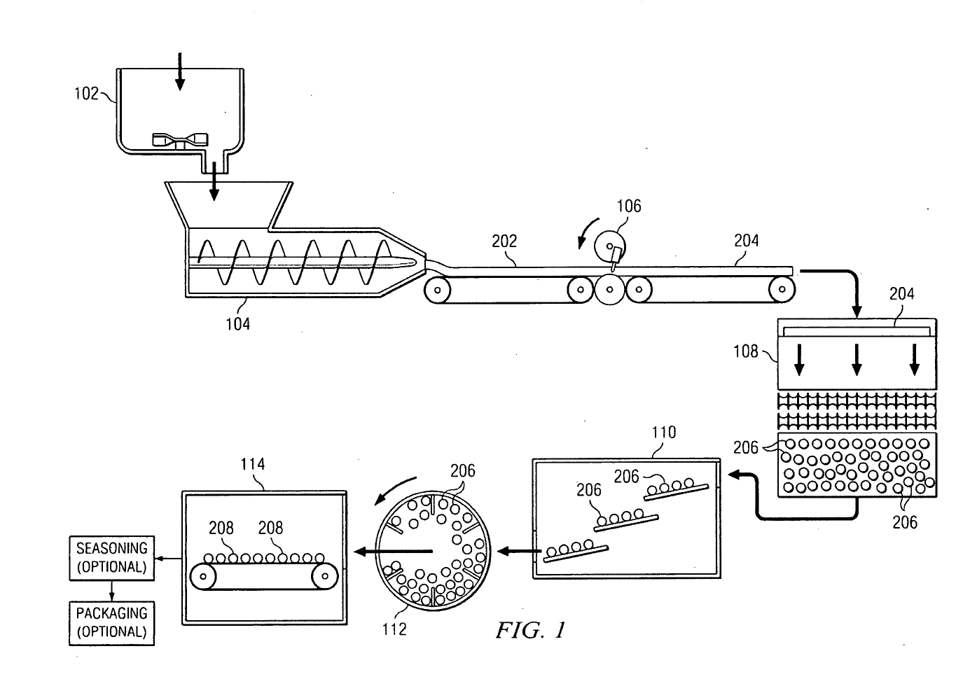

FIG. 1 depicts a schematic diagram of one embodiment of the present invention. The mixing process is depicted generally as mixer 102.

The fruit paste is then fed into an extruder 104. The extruder is preferably a single barrel, twin screw extruder that is operated at a temperature of between 27° C. in the barrel and 45° C. at the head, near the exit. It is preferably operated at a pressure between about 8 and 10 bars, but can be operated up to about 30 bars. The fruit paste is extruded through a die orifice with a substantially circular cross section. The diameter of the orifice is between about 10 millimeters and about 30 millimeters, but preferably about 20 millimeters. In one embodiment, the land length of the orifice is between about 40 millimeters and about 60 millimeters, but preferably about 50 millimeters. In a preferred embodiment, the orifice surface has a low coefficient of friction. The low friction orifice and long orifice length provide a smooth surface on the extrudate, which aids further processing.

The extrudate exiting the die orifice is referred to herein as a rope 202. The rope exits the extruder at between about 30° C. and 35° C. The water activity, Aw, of the extrudate is between about 0.5 and 0.6 when measured at about 28° C. The moisture content of the rope is between about 13% and about 18%, and its density is between about 1 and 1.1 grams/milliliter. The viscosity of the extrudate is between about 3000 Pa*s and about 3500 Pa*s when measured at a temperature between about 25° C. and about 45° C. and a work input of about 1.00 inverse seconds.

The rope does not expand and flash vapor when it exits the die orifice. The rope travels by conveyor from the extruder towards the core former, and is cut into rope sections before entering the core former. In one embodiment, the rope is cut into sections by a rotary cutter 106 mounted above the conveyor belt. In one embodiment, the rope sections 204 have a diameter of about 20 millimeters and a length less than or equal to the length of the grooved shaping cylinders 304 of the core former 108. In a preferred embodiment, for maximum efficiency, the rope section length is approximately equal to the length of the shaping cylinders in the core former 108. In one embodiment, the cut rope sections are coated with water after they are cut to aid processing and avoid sticking in the core former 108.

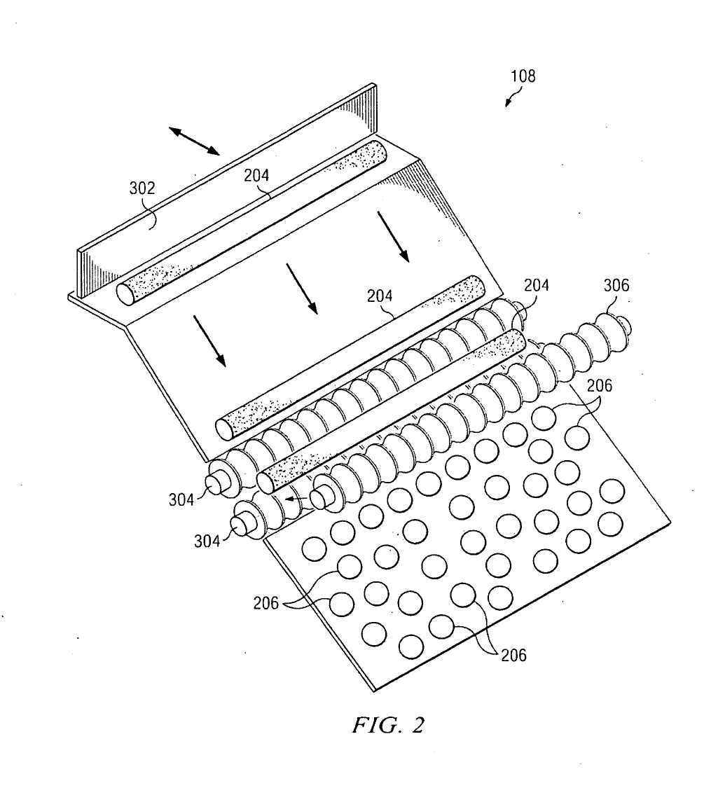

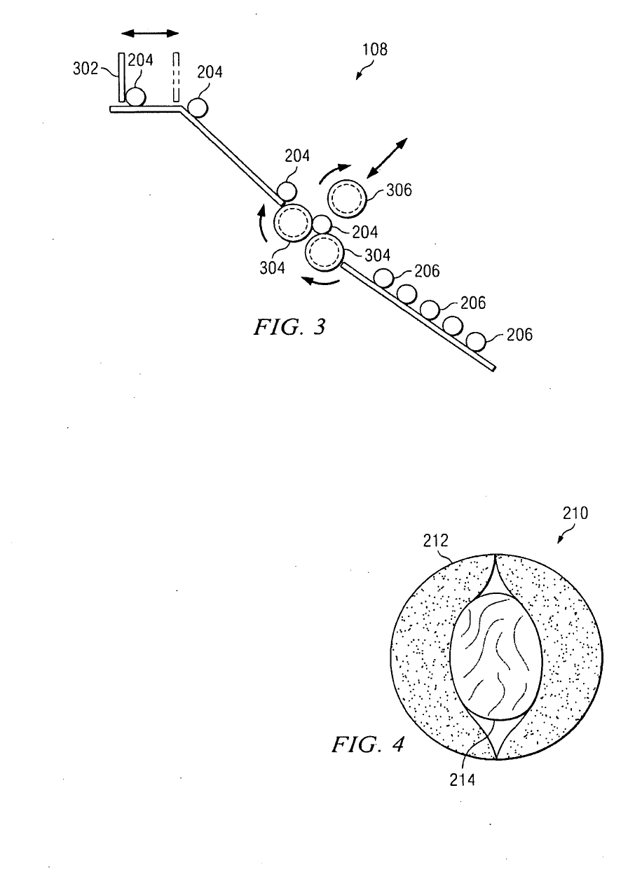

A perspective view of the core former is depicted in FIG. 2 and a profile view of the core former 108 is depicted in FIG. 3. It comprises three grooved shaping cylinders 304 and 306 that accept the fruit paste rope sections 204 and substantially form each of them into ellipsoid shaped cores 206. During operation, a pneumatic flap 302 pushes the rope section 204 off an edge and down an incline towards the two stationary grooved rollers 304. When the rope section arrives at the stationary rollers 304, the moving roller 306 travels towards the rope section 204, surrounds it, and cuts it into smaller sections corresponding to the complimentary grooves in the stationary and moving rollers 304 and 306. All three rollers continuously spin in the same direction during the core forming operation. The spinning action of the grooved rollers forms the smaller rope sections into ellipsoid shaped cores. The moving roller then moves away from the stationary rollers, allowing the cores 206 to drop down another incline and be transferred to further processing steps. The major diameter of the cores is between about 10 millimeters and about 30 millimeters.

In one embodiment, the cylinders 304 and 306 are continuously or periodically spray coated with an edible wax to prevent the rope sections 204 from sticking to the cylinders during processing. The wax is of the type used in confectionary and bakery applications. One example of a wax that can be used with the present invention is a product sold under the name BOESON-TRENNWAX by BakeMark Deutschland.

In a preferred embodiment, each of the rope sections is substantially formed into cores having a spheroid shape. In a most preferred embodiment, each rope section is substantially formed into cores having a sphere shape. The shaped cores exit the core former at a temperature between about 30° C. and about 35° C. They are then transferred to a cooler 110.

The cooler 110 is designed to keep the surface of the shaped cores 206 smooth and firm to avoid stickiness between the cores during the next unit operation, coating 112. In one embodiment, inside the cooler 110, the cores 206 roll down three levels of oscillating tables. However, any number of cooling stages or tables can be used. The residence time and temperature of the cores 206 as they exit the cooler 110 can be determined by adjusting the level of inclination, oscillation frequency and number of tables. The cooler 110 is equipped with an air conditioning system that blows cold air across the cores 206 as they roll through the cooler 110. In one embodiment, the air temperature is between about 4° C. and 15° C. In a preferred embodiment, the cores 206 exit the cooler at a product temperature of between about 10° C. and 20° C.

The cooled cores 206 are then coated 112 with a farinaceous coating. The coating is applied by tumbling the cores in a rotating drum (schematically depicted in FIG. 1) while the coating mixture is sprayed onto the cores 206. In a preferred embodiment, a plurality of coating layers is applied by injecting the coating mixture into the tumbler in cycles. Between each cycle, the coated cores 208 tumble and partially dry. In one embodiment, the a particular coating layer will dry enough for the following coating cycle after tumbling for between about 15 and about 20 minutes. In a preferred embodiment, the coating mixture is applied in cycles until the weight of the coated core piece 208 has been increased by between about 50% and about 100%, and in a most preferred embodiment, increased by between about 65% and about 85%. In one embodiment, the coating mixture comprises starch, sugar and water. The sugar and water can be provided in the form of a syrup. In a preferred embodiment, the weight ratio of sugar and water (or syrup) to starch is about 50:50, with a 5% variance. In another embodiment, the coating mixture comprises a mixture of different starches, sugar, water and Arabic gum. Optionally, food colorings can be added to the coating mixture to provide the consumer a visual appeal.

The coated cores 208 are then transferred to a hot air oven for baking 114. In a preferred embodiment, the coated cores 208 are baked in monolayer formation for about 20 minutes at an oven temperature between about 150° C. and 170° C. The baked cores 210 (depicted in FIG. 4) of the present invention are designed to provide the consumer with a multitextural experience. The outer coating 212 provides the consumer with a crispy, crunchy texture, while the inner core 214 provides a soft, smooth texture. Therefore, baking conditions should be chosen that do not materially dry the inner core of the snack piece. When the coated core exits the oven, the moisture content of the coating should be reduced to less than about 3% based on the weight of the coating, and the moisture content of the core should remain above 6% based on the weight of the core. In one embodiment, the composite fruit core comprises between about 50% and about 60% by weight of the baked, unseasoned snack product. In another embodiment, the coating comprises between about 40% and about 50% by weight of the baked, unseasoned snack product.

The coated cores can then optionally be topically seasoned 116 to taste, and sent to be packaged 118. In one embodiment, the topical seasoning is an oil-based seasoning. In one embodiment, the topical oil based seasoning comprises less than 12% by weight of the baked, seasoned snack piece.

### EXAMPLE 1

A mixture of dry ingredients was combined into plowshare mixer (manufactured by Littleford, model number FKM-300D). The dry mixture comprised about 53.9% apple powder, about 25.5% wheat flour, about 13.2% maltodextrin, about 3.9% modified (pregelatinized) starch (Instant Textaid A, manufactured by National Starch), about 2% citric acid, about 0.8% vitamin mixture, and about 0.7% natural flavor mixture. The mixture was mixed for approximately 10 minutes.

The dry mixture was then transferred into a planetary mixer (manufactured by Tonelli, model number EI200) with the wet ingredients. The wet mixture comprised about 50% polydcxtrose, about 41.7% water, and about 8.3% glycerin. The ingredients were mixed at room temperature for about 15 minutes to create a composite fruit paste.

The fruit paste was then transferred into an extruder (manufactured by Proform-France, model number GE75). The extruder was a twin screw, single clamshell barrel. The screws had a diameter of 100 millimeters and a power drive of about 7.5 kW. The barrel temperature was approximately 27° C. and the head temperature was about 45° C. The paste was extruded through an orifice with a 20 millimeter diameter and a 50 millimeter land length. The orifice surface was made of smooth plastic to reduce friction. The extrudate fruit paste rope was then cut into individual sections and coated with a layer of water.

The fruit paste sections were then transferred to a core former (manufactured by Proform-France, model number BF1000). The core former has a flap that pushes the rope sections into the three shaping cylinders. A wax coating was periodically sprayed on the shaping cylinders to prevent the cores from sticking to the cylinders during processing. The cores exited the former substantially in the shape of spheres.

The cores were then transferred to a cooler (manufactured by Proform-Prance, model number CT3032). The cooler contained three tables and passed air at a temperature between 4° C. and 15° C. across the cores until they exited the cooler. The cores exited the cooler at a product temperature of about 20° C.

The cooled cores were then panned in a rotating pear drum with a coating mixture comprising sugar, water, Arabic gum and starch. The coating mixture comprised about 25.6% sugar, about 23.1% water, about 1.3% Arabic gum, and about 50% starch. The coating was applied to the cores until the total weight of each coated piece was about 5 grams.

The coated cores were then baked in monolayer formation in a hot air oven (manufactured by Aeroglide). The air temperature was between about 150° C. and 170° C., and the coated pieces were baked for approximately 20 minutes. The coating on the baked cores had a moisture content of less than about 3% by weight of the coating. The fruit center had a moisture content of at least 6% by weight of the core. The cores were then seasoned and sent to be packaged.

1. A method for producing a coated, edible composite fruit core, said method comprising:
mixing dry ingredients comprising fruit powder, wheat flour, maltodextrin and starch to form a dry mix;
mixing said dry mix with wet ingredients comprising water, polydextrose and glycerin to produce a fruit paste with a moisture content by weight between about 7% and about 15%;
extruding said fruit paste to produce a fruit paste rope;
cutting said fruit paste rope to produce rope sections;
forming said rope sections into a plurality of composite fruit cores, wherein said cores are substantially in the shape of an ellipsoid;
cooling said composite fruit cores to produce cooled cores;
coating said cooled cores with a coating mixture comprising sugar, water and starch to produce coated cores having a coating; and
baking said coated cores until said coating comprises less than about 3% water based on the weight of said coating.

2. The method of claim 1 wherein said forming further comprises forming said rope sections into said plurality of said cores, wherein said cores are substantially in the shape of a spheroid.

3. The method of claim 1 wherein said forming further comprises forming said rope sections into said plurality of said cores, wherein said cores are substantially in the shape of a sphere.

4. The method of claim 1 wherein said forming further comprises rolling said rope sections between three grooved shaping rollers.

5. The method of claim 1 wherein said cooling further comprises cooling said cores inside a cooler comprising a plurality of inclined and oscillating cooling tables and at an air temperature between about 4° C. and 15° C.

6. The method of claim 1 wherein said cooling further comprises cooling said cores to a temperature between about 10° C. and about 20° C.

7. The method of claim 1 further comprising coating said fruit paste rope with water prior to said cutting.

8. The method of claim 4 further comprising coating said rollers with a wax coating.

9. The method of claim 1 wherein said fruit powder comprises apple powder.

10. The method of claim 1 wherein said mixing said dry ingredients further comprises mixing said dry ingredients in a plowshare mixer.

11. The method of claim 1 wherein said extruding further comprises extruding said fruit paste to produce said fruit paste rope wherein said fruit paste rope comprises a viscosity between about 3000 Pa*s and about 3500 Pa*s when measured at a temperature between about 25° C. and about 45° C.

12. A system for making individual, baked, coated, composite fruit core materials, said system comprising:
a mixer adapted to produce a composite fruit mixture;
an extruder adapted to extrude said fruit mixture into a fruit rope;
a cutter adapted to cut said fruit rope into rope sections;
a core former adapted to form each of said rope sections into a plurality of cores substantially in the shape of an ellipsoid;
a cooler adapted to cool said cores and provide cooled cores;
a coater adapted to coat said cooled cores with a starch based coating to produce coated cores;
an oven adapted to bake said coated cores to produce said individual, baked coated composite fruit core materials.

13. The system of claim 12 wherein said core former comprises three grooved shaping rollers.

14. The system of claim 12 wherein said cooler comprises three oscillating, inclined cooling tables and produces cooled cores at a temperature between about 10° C. and about 20° C.

15. The system of claim 12 wherein said coater is a tumbler.

16. A snack food comprising:
a composite fruit paste core material substantially ellipsoid in shape and comprising fruit powder, wheat flour, polydextrose, maltodextrin and a moisture content of at least 6% by weight;
a coating comprising sugar, starch and a moisture content of less than about 3% by weight.

17. The snack food of claim 16 wherein the total moisture content of said snack food is about 6% by weight.

18. The snack food of claim 16 wherein said fruit powder comprises apple powder.

19. The snack food of claim 16 wherein said fruit powder is at least one of apple, strawberry, blueberry, cranberry, plum, peach, mango, banana, pear, grape and orange.

20. The snack food of claim 16 wherein said composite fruit paste core comprises between about 50% and about 60% by weight of said snack food.
